(19) United States
(12) Patent Application Publication
(10) Pub. No.: US 2016/0012429 A1
(43) Pub. Date: Jan. 14, 2016

(54) POINT-OF-SALE PAYMENT SYSTEM AND RELATED METHODS

(71) Applicant: Nicholas Stanoszek, Strongsville, OH (US)

(72) Inventor: Nicholas Stanoszek, Strongsville, OH (US)

(73) Assignee: PAY(Q)R, LLC, Strongsville, OH (US)

(21) Appl. No.: 14/326,522

(22) Filed: Jul. 9, 2014

(51) Int. Cl. G06Q 20/38; G06Q 20/32; G06Q 20/20

(52) U.S. Cl. CPC G06Q 20/385; G06Q 20/202; G06Q 20/325

(57) ABSTRACT

Embodiments may relate to a co-operable set of computer programs for making electronic payments. The set of computer programs may be adapted to run on distributed computing devices such as, without limitation, a mobile computing device, a remote server, and a point-of-sale computer system. Together the set of co-operable computer programs may be adapted to carry store a tokenized payment credential on a remote server. The remote server may coordinate with a point-of-sale computer system to open a tab in response to a command received from a mobile computing device. The mobile computing device may receive and display data associated with the tab including items ordered, and prices of items ordered. The remote server may coordinate payment of the tab with an external credit card payment processor using the tokenized payment credential, in response to a command received from the mobile computing device.

### I. BACKGROUND OF THE INVENTION

A. Field of Invention

Embodiments of the invention may generally relate to electronically making payments to hospitality establishments.

B. Description of the Related Art

Devices and method for making remote payment for items are known in the art; however, all known devices and methods have certain shortcomings. For instance, in the case of the hospitality industry some systems used in bars and restaurants require point-of-sale computer systems to send menus or menu items to mobile computing devices so that a user may order from the merchant's food menu. Additionally, many known systems require the user's mobile computing device to store payment credentials which may significantly degrade security because such devices may be lost or stolen, or the payment credential may be intercepted during transmission. Furthermore, some known systems pass a credit card number to the point-of-sale computer system. One skilled in the art would appreciate that such a transmission could be intercepted and/or decrypted, or the point-of-sale system may be compromised resulting in the theft of a customer's credit card number.

Some embodiments of the present invention may provide one or more benefits or advantages over the prior art.

### II. SUMMARY OF THE INVENTION

Some embodiments may relate to a co-operable set of computer programs for making electronic payments from a mobile computing device, comprising a set of instructions portions of which are executable on at least a mobile computing device, a remote server, and a point-of-sale computer system and the co-operable set of computer programs being adapted to carry out the acts of: storing a tokenized payment credential on a remote server; the remote server coordinating with a point-of-sale computer system to open a tab in response to a command received from a mobile computing device; the mobile computing device receiving and displaying data associated with the tab including items ordered, and prices of items ordered; and the remote server coordinating payment of the tab with an external credit card payment processor using the tokenized payment credential, in response to a command received from the mobile computing device.

According to some embodiments the act of the remote server coordinating with a point-of-sale computer system to open a tab further comprises the acts of: the mobile computing device receiving a Location ID comprising a unique indicium identifying the point-of-sale computer system; and the mobile computing device transmitting the Location ID to the remote server and requesting to open the tab.

According to some embodiments the step of the remote server coordinating with a point-of-sale computer system to open a tab further comprises the acts of providing the point-of-sale computer system with a Customer ID comprising a unique indicium identifying a customer.

Some embodiments may be further adapted to carry out the act of the mobile computing device determining a position of the mobile computing device by using GPS features of the mobile computing device.

Some embodiments may be further adapted to carry out the acts of: the mobile computing device transmitting the position of the mobile computing device to the remote server; the remote server comparing the position of the mobile computing device to the positions of establishments known to be interoperable with the co-operable set of computer programs, the known interoperable establishments being within a predefined distance of the mobile computing device; the remote server returning to the mobile computing device a list of establishments known to be interoperable with the set of co-operable computer programs, the known interoperable establishments being within the predefined distance of the mobile computing device, wherein the list of known interoperable establishments includes Location IDs comprising unique indicia identifying at least one point-of-sale computer system of each known interoperable establishment of the list; the mobile computing device enumerating the list of interoperable establishments within the predefined distance of the mobile computing device in the form of an interactive list, wherein list items are user-selectable through interacting with a control of the mobile computing device; and a user of the mobile computing device selecting one of the known interoperable establishment from the interactive list.

According to some embodiments the act of the remote server coordinating with a point-of-sale computer system to open a tab further comprises the acts of: the mobile computing device issuing a request to the remote server to open a tab on the point-of-sale computer system of the selected known interoperable establishment; and the remote server relaying the request of the mobile computing device to open a tab to the point-of-sale computer system of the selected known interoperable establishment.

Some embodiments may be further adapted to carry out the act of the mobile computing device obtaining, from the point-of-sale computer system, a Location ID comprising a unique indicium identifying the point-of-sale computer system.

Some embodiments may be further adapted to carry out the act of obtaining the Location ID from a wireless beacon signal.

According to some embodiments the act of storing a tokenized payment credential on a remote server further comprises the act of erasing the payment credential from the mobile computing device.

According to some embodiments the act of the mobile computing device receiving and displaying data associated with the tab including items ordered, and prices of items ordered further comprises the acts of: the remote server receiving tab data from the point-of-sale computer system including items ordered, and prices of items ordered; the remote server transmitting at least a portion of the tab data received from the point-of-sale computer system to the mobile computing device; and the mobile computing device displaying at least a portion of the tab data received from the point-of-sale computer system.

According to some embodiments the act of the remote server coordinating payment of the tab further comprises the acts of: the mobile computing device transmitting instructions to the remote server to pay at least a portion of the tab; the remote server coordinating payment with an external credit card payment processor; the remote server transmitting a payment complete message to the point-of-sale computer system; and the point-of-sale computer system recording at least a portion of the tab as paid.

Some embodiments may be further adapted to carry out the act of providing a user with an option to join a preexisting tab of another, provided that the tab owner grants permission to join.

Some embodiments may be further adapted to carry out the act of providing an interactive list of items ready for payment, wherein list items are selectable through interacting with a touch screen of the mobile computing device.

Some embodiments may be further adapted to carry out the act of allowing selection of less than all of the items ready for payment.

Some embodiments may be further adapted to carry out the act of holding open a tab in association with a tab owner after a payment is made if the tab continues to have a non-zero amount due.

Other benefits and advantages will become apparent to those skilled in the art to which it pertains upon reading and understanding of the following detailed specification.

Throughout the specification terms which may suggest a particular order of steps may be used; however, it will be understood to those skilled in the art that certain steps may be executed in a different order, and that terms suggesting a particular order are used only for the sake of convenience rather that to limit the invention to a particular order of steps.

Additionally, throughout the specification reference is made to various servers and computer systems. One skilled in the art will appreciate that the distinction between one server or computer and another is a logical and not necessarily physical distinction. Accordingly, multiple servers may be physically installed or located on a single computer hard drive or they may be separate depending on the topology of any particular deployment of an embodiment. Similarly, the functions attributed herein to one or more of the servers or computers may be allocated as needed to other servers or computers without departing from the scope of the invention.

As used herein the term “interoperable establishments” is used to indicate a merchant operating a point-of-sale computer system on which a software component of an embodiment is operably installed so that the embodiment can make API calls to, and otherwise exchange data with, the point-of-sale computer system to carry out one or more processes or steps of the embodiment.

As used herein the term “external” is used in connection with, for instance, credit card processors and/or servers to indicate that the item to which the term “external” refers is not an element of the invention, but rather that embodiments may interact with the external item in the course of carrying out one or more processes or steps of an embodiment.

As used herein the term “co-operable set of computer programs” is used to indicate that a plurality of computer programs may need to interact in order to carry out processes and/or steps of an embodiment. For instance, a set of co-operable computer programs may be installed on separate computers distributed over a network such as the Internet.

As used herein the term tab refers to an electronic version of a customary bar or restaurant bill. Accordingly, tab data and data associated with a tab can include one or more of items ordered, the prices of items ordered, gratuities, taxes, service fees, or other charges as well as a Tab ID (i.e. a unique indicium identifying a tab), a Customer ID (i.e. a unique indicium identifying a customer), and/or a Location ID (i.e. a unique indicium identifying a merchant location or point-of-sale computer system). As used herein the term “open a tab” or similar references to opening a tab can include opening a new tab, joining a pre-existing tab, or both.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1A is a diagram of a mobile computing device displaying a screen for selecting a merchant;

FIG. 1B is a diagram of a mobile computing device displaying a screen for opening a tab;

FIG. 1C is a diagram of a mobile computing device displaying a screen for monitoring a tab;

FIG. 1D is a diagram of a mobile computing device displaying a screen for preparing to pay a tab;

FIG. 1E is a diagram of a mobile computing device displaying a screen for authorizing payment of a tab;

FIG. 1F is a diagram of a mobile computing device displaying a screen for verifying payment of a tab;

FIG. 1G is a diagram of a mobile computing device displaying a screen for selecting items of a tab for payment;

FIG. 1H is a diagram of a mobile computing device displaying a screen for preparing to pay selected items of a tab;

FIG. 1I is a diagram of a mobile computing device displaying a screen for indicating items of a tab which have been paid;

FIG. 2 is a schematic diagram showing a process for tokenizing a payment credential;

FIG. 3A is a schematic diagram showing a process for inputting merchant data and fulfilling requests for merchant data made by a mobile computing device;

FIG. 3B is a schematic diagram showing a mobile computing device obtaining a Location ID directly from a point-of-sale computer system;

FIG. 4 is a schematic diagram showing a process for opening a tab; and

FIG. 5 is a schematic diagram showing a process for paying a tab.

### IV. DETAILED DESCRIPTION OF THE INVENTION

Embodiments of the invention may include a computer program as well as related systems and methods for wirelessly making electronic payments from a mobile computing device to a nearby merchant. For instance, an embodiment may include software and/or hardware for opening a tab or joining a preexisting tab at a bar or restaurant, and may include features for viewing a real time list of items on a tab as well as features for paying all or part of a tab. Furthermore, embodiments may allow a consumer to make payment to a merchant using tokenized credit cards rather than storing sensitive data on unsecure devices such as mobile phones. Optionally, a user may join an existing tab with the approval of the tab owner. Furthermore, embodiments may allow users to claim portions of a tab for payment. For instance, a user may claim particular items for payment, or may pay a particular amount or percentage of a tab.

An embodiment comprising a computer program may be functionally installed on a mobile computing device such as, without limitation, a mobile phone, a tablet computer, a laptop computer, a personal digital assistant, or the like. The mobile computing device may have GPS (global positioning system) features adapted to determine the position of the device, and the computer program may be adapted to receive position data from the GPS features. The mobile computing device may also include wireless communication features such as cellular telephone features and/or networking features such as Wi-Fi, Bluetooth, Bluetooth Low Energy and/or other similar wireless networking technologies.

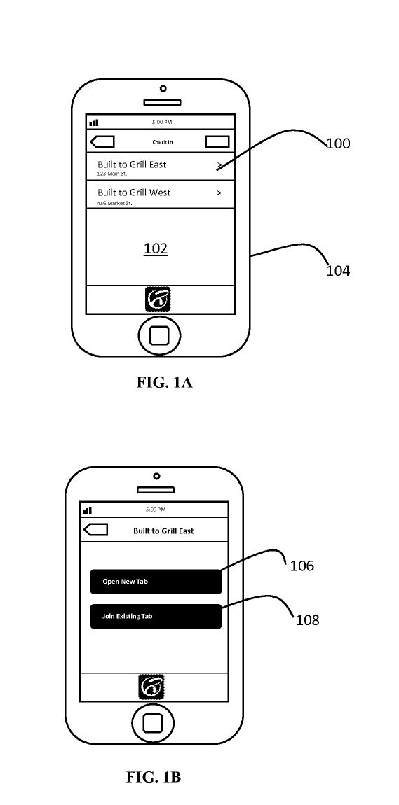

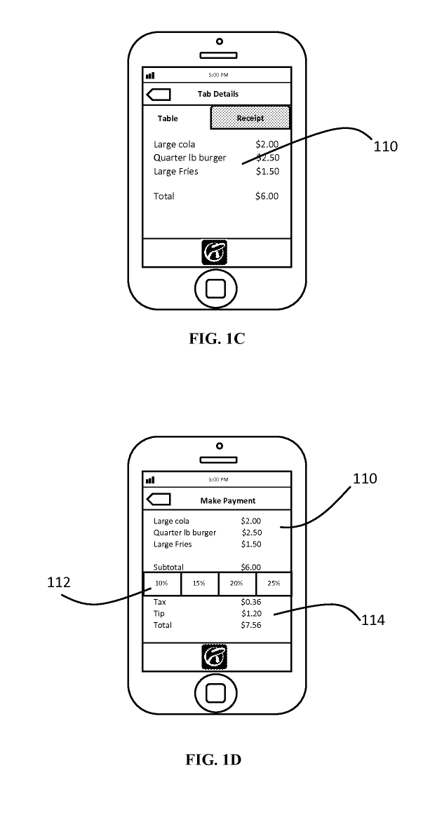

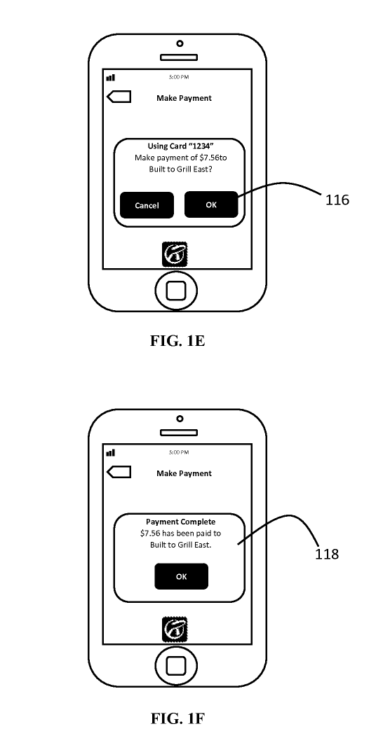

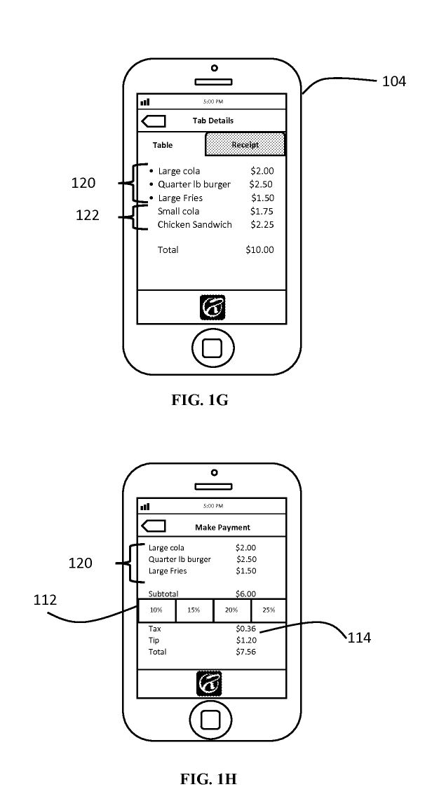

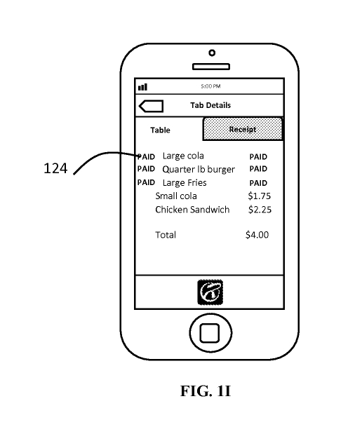

Referring now to the drawings wherein the showings are for purposes of illustrating embodiments of the invention only and not for purposes of limiting the same, FIGS. 1A through 1I illustrate various screens of a user interface of an embodiment. For instance, in FIG. 1A a list 100 of nearby establishments known to be interoperable with the embodiment is displayed on a touch screen 102 of a mobile computing device 104. When a user selects “Built to Grill East” from the list 100 by interacting with the touch screen 102 the user interface displays the screen of FIG. 1B which provides the user with button controls for either opening a new tab 106 or joining an existing tab 108. Though not shown, if the user were to tap control 108 to join an existing tab, the user may be required to indicate the tab owner and the embodiment would request the tab owner's authorization for the user to join his tab.

Assuming the user taps control 106 to create a new tab, the user interface displays the screen of FIG. 1C, which shows a list 110 of activity on the tab. For example, the owner of the example tab shown in FIG. 1C has ordered a large soda for $2.00, a quarter pound hamburger for $2.50, and large fry for $1.50 totaling $6.00 before tax and tip. As the user orders new items through traditional interaction with hospitality staff, the newly ordered items may be pushed to the user's mobile computing device 104 and displayed by the user interface. Accordingly, the user has a real time view of its tab. FIG. 1 D illustrates a screen of the user interface which presents a user with the itemized list 110 of FIG. 1C in addition to a tool 112 for selecting a tip amount according to percentage of the subtotal, and a listing 114 of tax, tip amount in dollars, and the total amount due.

When the user interacts with a payment control of the user interface a payment screen such as the one shown in FIG. 1E may be displayed indicating the credit card to use used for payment, the amount to be paid, a request for authorization to make payment. The user may tap the OK button control 116 indicating its authorization. FIG. 1F illustrates a payment confirmation screen 118 which may be displayed by the user interface if payment is authorized and successfully made.

FIG. 1G illustrates a screen of the user interface where a shared bill may be divided among users of an embodiment. The user of the mobile computing device 104 shown in FIG. 1G is provided with a list of all items on a shared tab. The user may select particular items to pay for, for instance, by tapping an item. In this example, a set of claimed items 120 are indicated by a circular bullet point to the left of the item, which is absent from the set of unclaimed items 122. When the user is satisfied with its selection and ready to pay the user may indicate so through interaction with the user interface, and may then be presented with a screen such as the one shown in FIG. 1H, which shows only the claimed items 120. FIG. 1H also shows the tip tool 112 and tax, tip, and total amount due 114. FIG. 1I illustrates a screen that a tab owner may be presented with in a shared tab scenario after a portion of the tab has been paid. Items which have been paid for are marked 124 to visually indicate their status as paid. However, the tab remains open so that the tab owner remains ultimately responsible for any items not paid for by others in the shared tab. Accordingly, the tab is not closed until all items are paid.

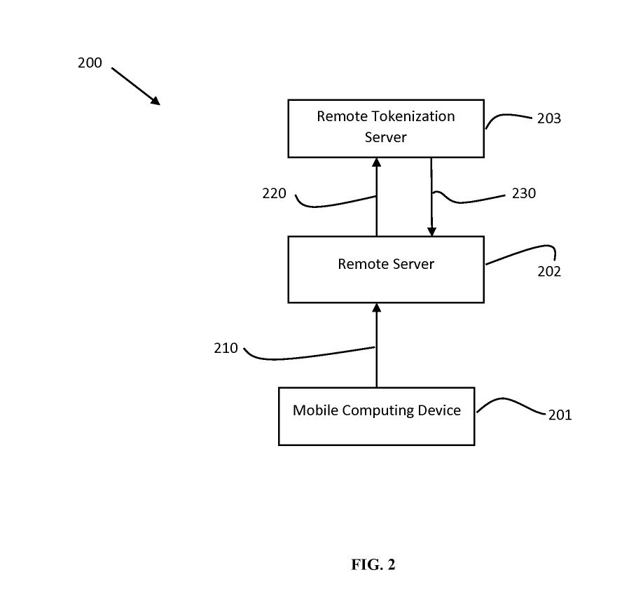

FIG. 2 illustrates a process 200 by which an embodiment may obtain a tokenized payment credential. In step 210 a mobile computing device 201 securely communicates a payment credential to a remote server 202. Step 210 may occur by way of an encrypted electronic data transmission. After step 210 the payment credential is erased from the mobile computing device 201, thereby further enhancing security. The remote server 202 communicates the payment credential in step 220 to a remote tokenization sever 203. The remote tokenization server 203 converts the payment credential to a token, which may be an alphanumeric string having no mathematical relationship to the original payment credential. In step 230 the remote tokenization server 203 transmits the token to the remote server 202, which stores the token in association with a user account for fulfilling future payment orders. Tokens may be useable in multiple transactions, may be single-use, and/or may be replaced after a predefined number of uses or period of time.

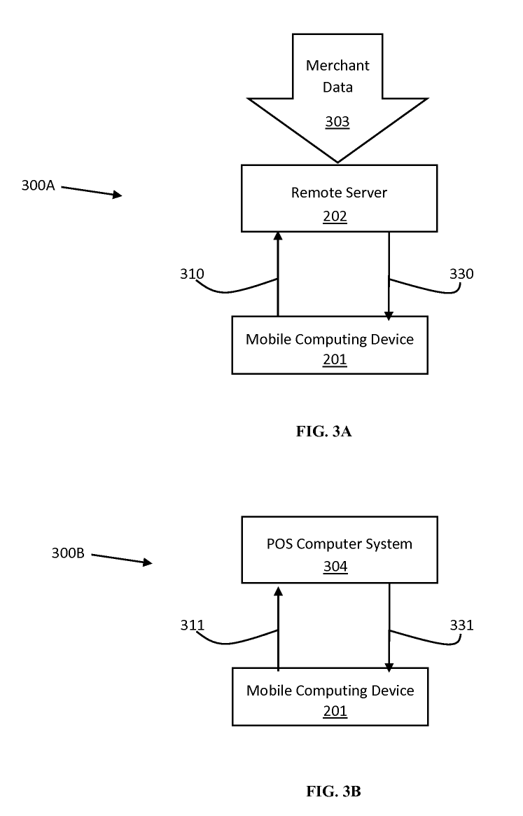

FIG. 3A illustrates a process 300 by which an embodiment may identify and/or select a nearby establishment known to be interoperable with the embodiment. Data identifying interoperable merchant locations is inputted 303 into the remote server 202. The merchant data includes information defining a geographic location such as cartographic coordinates or a street address and may also include a unique indicium identifying the merchant which is referred to herein as a Location ID. Other data may be included as deemed appropriate or convenient including, without limitation, a business name, a rating score indicating a predicted consumer experience, content describing the establishment, and/or branding data and images.

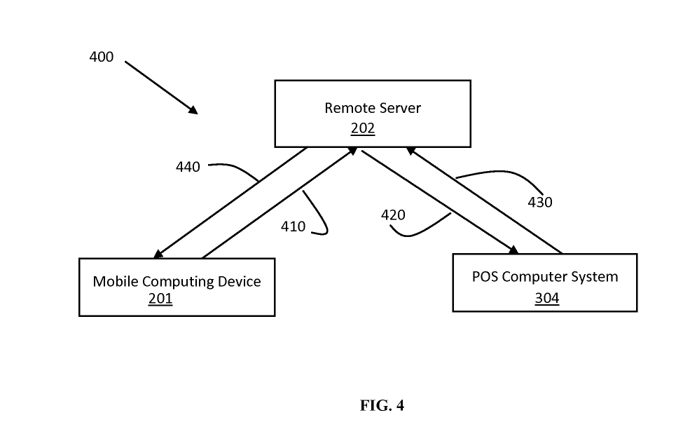

With continuing regard to FIG. 3A, mobile computing device 201 may obtain is position using Global Positioning System (GPS) features of the device 201 and transmit 310 its position to the remote server 202 along with a request for a list of nearby interoperable establishments. The remote server 202 may then compare the position of the device 201 to the known geographic locations of interoperable establishments within a predefined distance of the device 201 and thus retrieve a list of nearby interoperable establishments. The remote server 202 may then transmit 330 the list of nearby interoperable establishments back to the mobile computing device 201 including each establishment's Location ID. The list transmitted in step 330 may be presented to a user along with interactive features allowing a user to select an item from the list by interacting with the mobile computing device 201 through, for instance, a touch screen. Selecting an item from the list may display additional data about the establishment and/or may present the user with features for opening a tab at the establishment as shown in more detail in FIG. 4.

Alternatively or additionally, an embodiment may transmit a zip code to the remote server 202 rather than GPS coordinates. In some embodiments the zip code may be selected by the user and may be any zip code regardless of the position of the mobile computing device 201, but in some embodiments the zip code may be obtained using the GPS features of the mobile computing device 201 to determine the zip code where the mobile computing device 201 is presently located. Without regard to how the zip code is obtained or selected, the embodiment may transmit the zip code to the remote server 202 which may then compare the zip code to the zip codes of known interoperable establishments in the same or nearby zip codes. Similar to the embodiment illustrated in FIG. 3A, the remote server 202 may then transmit 330 a list of nearby interoperable establishments back to the mobile computing device 201 including each establishment's Location ID. The list transmitted in step 330 may be presented to a user along with interactive features allowing a user to select an item from the list by interacting with the mobile computing device 201 through, for instance, a touch screen.

FIG. 3B illustrates another process by which an embodiment may identify and/or select an establishment that is interoperable with the embodiment. According to FIG. 3B, if the mobile computing device 201 is within range of a short-range wireless beacon of the POS (point of sale) computer system 304 it may identify the POS computer system 304 as an interoperable establishment based on the data content of the beacon signal, which may include the merchant's Location ID. Beacon signals contemplated in according to the process of FIG. 3B include Bluetooth Low Energy beacons, WiFi beacons, ZigBee beacons, iBeacons, Near Field Communication beacons, and the like. Data from the beacon signal may be presented to a user along with interactive features allowing a user to select the establishment by interacting with the mobile computing device 201 through, for instance, a touch screen. Selecting the establishment may result in opening a tab at the establishment or may present the user with features for opening a tab as shown in more detail in FIG. 4.

FIG. 4 illustrates a process 400 by which an embodiment may be used to open and monitor a tab remotely. According to FIG. 4 a mobile computing device 201 sends a request 410 to open a tab at a selected merchant establishment to the remote server 202. The request 410 may include the merchant's Location ID, and may include security credentials identifying the mobile computing device 201 to the remote server 202. The remote server may then make an API (application programming interface) call 420 to the POS computer system 304 relaying the request to open a tab including a unique identifying indicium of the user, i.e. a Customer ID. The POS computer system 304 may then create a new tab including a unique identifying indicium of the tab, i.e. a Tab ID. Additionally, the tab may be associated with the Customer ID of the user for whom the tab was opened and the Location ID of the merchant. In step 430 the POS computer system 304 transmits an acknowledgement back to the remote server 202 indicating that the tab has been opened, and providing the Tab ID which the remote server 202 may store for routing future communications related to the tab.

With continuing regard to FIG. 4, the user of the mobile device 201 may be physically located in to establishment and may order items from a traditional hardcopy menu according to customary methods. The merchant inputs ordered items into the POS computer system 304 in association with Tab ID of the tab opened for the user of the mobile device and in association with its Customer ID. The remote server 202 may periodically call the POS computer system 304 to determine whether the tab has new or updated data, e.g. new items have been ordered or previously ordered items have been cancelled or modified. Alternatively, the POS computer system 304 may push new or updated tab data to the remote server 202 without the need for periodic calls. When the remote server 202 receives new or updated tab data it may then push the data 440 to the mobile computing device 201 thereby keeping the customer apprised of its bill in real time.

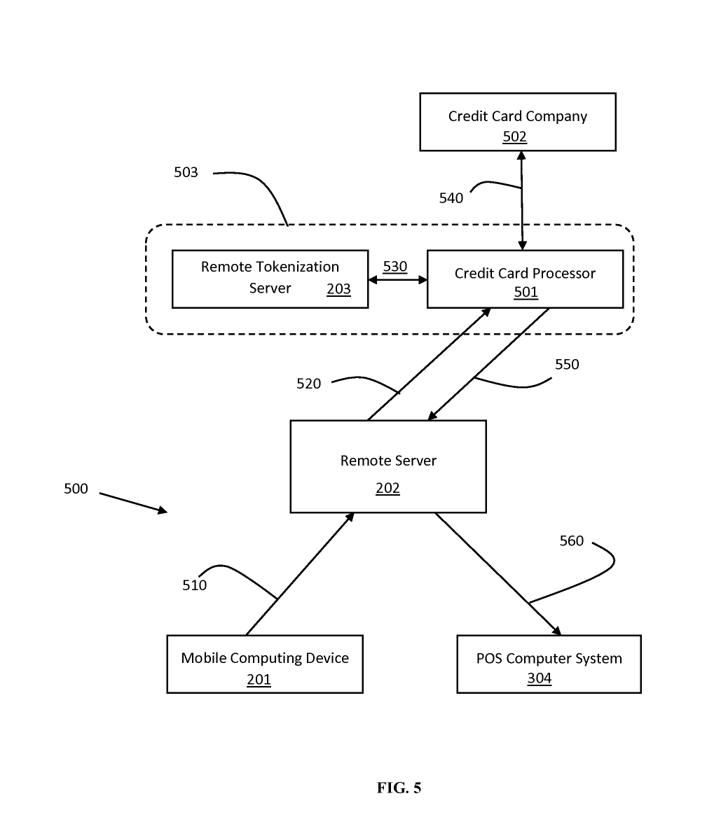

FIG. 5 illustrates a process 500 by which an embodiment may be used to coordinate payment of a tab. According to the process of FIG. 5, a user of the mobile communications device 210 initiates payment by interacting with the mobile communications device 210, for instance, by tapping a pay button or similar control, which causes the mobile communications 201 device to transmit in step 510 a pay request to the remote server 202 which may use the Customer ID, Location ID, and the Tab ID to match the payment request to a particular user, merchant, and tab. The remote server 202 then transmits in step 520 a corresponding payment order to a credit card processor 501 including the customer's tokenized payment credentials. The credit card processor 501 may convert the token back to its original form by retrieving the original form from the remote tokenization server 203 in step 530 and then charges the customer's credit card account in step 540 held by a credit card company 502. Box 503 indicates that the remote tokenization server 203 and the credit card processor 501 are under common control, such as through common ownership; however, this is not a requirement of the invention. In step 550 the credit card processor 501 transmits a payment complete notice corresponding to the charge of step 540 to the remote server 202. In step 560 the remote server 202 sends a notice to the merchant's POS computer system 304 that payment of a particular tab has been made as well as other relevant data such as the amount paid and the amount of any tip. The merchant POS computer system 304 then closes the corresponding tab. The merchant and others may be paid according to procedures and methods of the credit card processor 501 and the credit card company 502.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I/we claim:

1. A co-operable set of computer programs for making electronic payments from a mobile computing device, comprising a set of instructions portions of which are executable on at least a mobile computing device, a remote server, and a point-of-sale computer system and the co-operable set of computer programs being adapted to carry out the acts of:
storing a tokenized payment credential on a remote server;
the remote server coordinating with a point-of-sale computer system to open a tab in response to a command received from a mobile computing device;
the mobile computing device receiving and displaying data associated with the tab including items ordered, and prices of items ordered; and
the remote server coordinating payment of the tab with an external credit card payment processor using the tokenized payment credential, in response to a command received from the mobile computing device.

2. The co-operable set of computer programs of claim 1, wherein the act of the remote server coordinating with a point-of-sale computer system to open a tab further comprises the acts of:
the mobile computing device receiving a Location ID comprising a unique indicium identifying the point-of-sale computer system; and
the mobile computing device transmitting the Location ID to the remote server and requesting to open the tab.

3. The co-operable set of computer programs of claim 2, wherein the act of the remote server coordinating with a point-of-sale computer system to open a tab further comprises the acts of providing the point-of-sale computer system with a Customer ID comprising a unique indicium identifying a customer.

4. The co-operable set of computer programs of claim 1, further adapted to carry out the act of the mobile computing device determining a position of the mobile computing device by using GPS features of the mobile computing device.

5. The co-operable set of computer programs of claim 4, further adapted to carry out the acts of:
the mobile computing device transmitting the position of the mobile computing device to the remote server;
the remote server comparing the position of the mobile computing device to the positions of establishments known to be interoperable with the co-operable set of computer programs, the known interoperable establishments being within a predefined distance of the mobile computing device;
the remote server returning to the mobile computing device a list of establishments known to be interoperable with the set of co-operable computer programs, the known interoperable establishments being within the predefined distance of the mobile computing device, wherein the list of known interoperable establishments includes Location IDs comprising unique indicia identifying at least one point-of-sale computer system of each known interoperable establishment of the list;
the mobile computing device enumerating the list of interoperable establishments within the predefined distance of the mobile computing device in the form of an interactive list, wherein list items are user-selectable through interacting with a control of the mobile computing device; and
a user of the mobile computing device selecting one of the known interoperable establishment from the interactive list.

6. The co-operable set of computer programs of claim 5, wherein the act of the remote server coordinating with a point-of-sale computer system to open a tab further comprises the acts of:
the mobile computing device issuing a request to the remote server to open a tab on the point-of-sale computer system of the selected known interoperable establishment; and
the remote server relaying the request of the mobile computing device to open a tab to the point-of-sale computer system of the selected known interoperable establishment.

7. The co-operable set of computer programs of claim 1, further adapted to carry out the act of the mobile computing device obtaining, from the point-of-sale computer system, a Location ID comprising a unique indicium identifying the point-of-sale computer system.

8. The co-operable set of computer programs of claim 7, further adapted to carry out the act of obtaining the Location ID from a wireless beacon signal.

9. The co-operable set of computer programs of claim 1, wherein the act of storing a tokenized payment credential on a remote server further comprises the act of erasing the payment credential from the mobile computing device.

10. The co-operable set of computer programs of claim 1, wherein the act of the mobile computing device receiving and displaying data associated with the tab including items ordered, and prices of items ordered further comprises the acts of:
the remote server receiving tab data from the point-of-sale computer system including items ordered, and prices of items ordered;
the remote server transmitting at least a portion of the tab data received from the point-of-sale computer system to the mobile computing device; and
the mobile computing device displaying at least a portion of the tab data received from the point-of-sale computer system.

11. The co-operable set of computer programs of claim 1, wherein the act of the remote server coordinating payment of the tab further comprises the acts of:
the mobile computing device transmitting instructions to the remote server to pay at least a portion of the tab;
the remote server coordinating payment with an external credit card payment processor;
the remote server transmitting a payment complete message to the point-of-sale computer system; and
the point-of-sale computer system recording at least a portion of the tab as paid.

12. The co-operable set of computer programs of claim 1 being further adapted to carry out the act of providing a user with an option to join a preexisting tab of another, provided that the tab owner grants permission to join.

13. The co-operable set of computer programs of claim 1 being further adapted to carry out the act of providing an interactive list of items ready for payment, wherein list items are selectable through interacting with a touch screen of the mobile computing device.

14. The co-operable set of computer programs of claim 13 being further adapted to carry out the act of allowing selection of less than all of the items ready for payment.

15. The co-operable set of computer programs of claim 1, further adapted to carry out the act of holding open a tab in association with a tab owner after a payment is made if the tab continues to have a non-zero amount due.

16. The co-operable set of computer programs of claim 1, further adapted to carry out the act of the mobile computing device receiving a zip code inputted by a user of the mobile communication device or communicated to the mobile computing device from the remote server based on GPS coordinates of the mobile computing device.

17. The co-operable set of computer programs of claim 16, further adapted to carry out the acts of:
the mobile computing device transmitting the zip code to the remote server;
the remote server comparing the zip code from the mobile computing device to the zip codes of establishments known to be interoperable with the co-operable set of computer programs, the known interoperable establishments being within the zip code from the mobile computing device or within one or more zip codes contiguous with the zip code from the mobile computing device;
the remote server returning to the mobile computing device a list of establishments known to be interoperable with the set of co-operable computer programs, the known interoperable establishments being within the zip code from the mobile computing device or within one or more zip codes contiguous with the zip code from the mobile computing device, wherein the list of known interoperable establishments includes Location IDs comprising unique indicia identifying at least one point-of-sale computer system of each known interoperable establishment of the list;
the mobile computing device enumerating the list of interoperable establishments in the form of an interactive list, wherein list items are user-selectable through interacting with a control of the mobile computing device; and
a user of the mobile computing device selecting one of the known interoperable establishment from the interactive list.

18. The co-operable set of computer programs of claim 17, wherein the act of the remote server coordinating with a point-of-sale computer system to open a tab further comprises the acts of:
the mobile computing device issuing a request to the remote server to open a tab on the point-of-sale computer system of the selected known interoperable establishment; and
the remote server relaying the request of the mobile computing device to open a tab to the point-of-sale computer system of the selected known interoperable establishment.

19. A co-operable set of computer programs for making electronic payments from a mobile computing device, comprising a set of instructions portions of which are executable on at least a mobile computing device, a remote server, and a point-of-sale computer system and the co-operable set of computer programs being adapted to carry out the acts of:
storing a tokenized payment credential on a remote server and never storing a tokenized or non-tokenized payment credential on a mobile computing device;
the remote server coordinating with a point-of-sale computer system to open a tab in response to a command received from the mobile computing device;
the mobile computing device receiving and displaying data associated with the tab including items ordered, and prices of items ordered; and
the remote server coordinating payment of the tab with an external credit card payment processor using the tokenized payment credential, in response to a command received from the mobile computing device.
